(19) United States
(12) Patent Application Publication
(10) Pub. No.: US 2015/0339697 A1
(43) Pub. Date: Nov. 26, 2015

(54) DATA TRANSMISSION APPARATUS FOR RECORDING VISIT DATA OF WIRELESS COMMUNICATION DEVICE

(71) Applicant: 2GATHER INC., Seoul (KR)

(72) Inventors: Sang Jun PARK, Seoul (KR); Yeong Woong PARK, Seoul (KR); Sung Ho PARK, Seoul (KR); Jun Ho CHOI, Gyeonggi-do (KR)

(21) Appl. No.: 14/647,038

(22) PCT Filed: Nov. 20, 2013
(86) PCT No.: PCT/KR2013/010561

§ 371 Date: May 22, 2015

(30) Foreign Application Priority Data
Nov. 23, 2012 (KR) 10-2012-0133695

(51) Int. Cl. G06Q 30/02; G06F 3/0488; H04L 29/08; H04W 4/02; G06F 3/0484

(52) U.S. Cl. CPC G06Q 30/0226; H04W 4/02; G06F 3/04842; H04L 67/10; G06F 3/0488

(57) ABSTRACT

A method and apparatus for validating a service user's visit to a service-providing place are provided.

According to an exemplary embodiment, a data transmission device, which is connected to a server and transmits visit data to a wireless communication device, is provided. The data transmission unit includes: a handle unit, which is formed of a conductive material; a button unit, which is connected to the handle unit and transmits data indicating that visit data is to be transmitted to the wireless communication device to the server in response to a button thereof being pressed; and a touch screen touch unit which is connected to the button unit and allows an electric signal to be input to a touch screen of the wireless communication device, wherein the visit data is transmitted to the wireless communication device if the button is pressed and an electric signal is input to the touch screen.

### RELATED APPLICATIONS

This patent application claims the benefit under 35 U.S.C. §371 of International Application Number PCT/KR2013/010561, filed Nov. 20, 2013, which claims priority to Korean Patent Application No. 10-2012-0133695, filed Nov. 23, 2012, both of which are incorporated herein by reference.

### TECHNICAL FIELD

The invention relates to a system and method for recording visit data of a wireless communication device, and particularly, to a system and method for recording visit data in a wireless communication device upon a visit to a particular location.

### BACKGROUND ART

Conventionally, in order to earn rewards points or to be rewarded with additional services, for example, a restaurant or a café, service users are supposed to present upon a visit to a service-providing place a rewards card that they have received from the service-providing place online or offline in advance and to have their accumulated number of visits to the service-providing place checked.

Accordingly, the service users are required to carry multiple rewards cards with them for each restaurant or café that they frequent, which, however, is very inconvenient. Also, the service users may not be able to have their visit validated if they forget to bring the rewards card with them.

To address these problems, a method has been suggested, and has become widespread, in which smartphones are used to replace rewards cards. For example, the service users may have their visit to a restaurant or café recorded in a server by capturing an image of a Quick Response (QR) code installed in the service-providing place with a smartphone.

This QR code method, however, cannot exclude the possibility of the service users using the image of the QR code elsewhere to falsely validate themselves as visiting the service-providing place when they are not.

The QR code method may be assisted with the use of Global Positioning System (GPS) information to properly determine whether the service users are actually paying a visit to the service-providing place. However, the service users still can falsely validate themselves as visiting the service-providing place when they are not, simply by being within an error range of the exact GPS location of the service-providing place.

In addition to the issue of falsely validated visits, there are concerns over false evaluation of the service-providing place or each individual service provider at the service-providing place by service users who have not actually visited the service-providing place.

Conventionally, rewards points are generally earned and accumulated on the basis of service-providing places, such as coffee shops or hair shops, rather than on the basis of individual service providers, such as baristas or hair designers, and there are not adequate ways yet to earn rewards points from, and evaluate, each individual service provider.

In the meantime, Korean Patent Application Publication No. 10-2004-0063420 (hereinafter, Patent Document 1) discloses a rewards point providing method using a mobile barcode, comprising the steps of displaying a barcode on the screen of a terminal (S101), scanning the displayed barcode (S102), converting the scanned barcode into data that can be processed (S103), creating payment data, including the data obtained from the scanned barcode and an amount to be paid, and sending the payment data to a main server (S104), allowing the main server to analyze the payment data and to identify membership and the amount to be paid (S105), making a payment in the amount to be paid and calculating the amount of points to be awarded (S106), accumulating the calculated rewards points (S107), and sending payment confirmation information and accumulated rewards points information (S108).

In this rewards point providing method, a barcode may be displayed on the screen of a terminal and may be scanned to perform the functions of a typical rewards card.

However, Patent Document 1 provides neither as real an interface as an actual rewards card nor the fun of earning and accumulating rewards points with the actual rewards card. Also, Patent Document 1 neither provides the same interface as that of paper coupons that store clerks and customers are used to, nor guarantees much fun other than that of collecting coupons through a unique data transmission method.

### DISCLOSURE

### Technical Problems

Simplified descriptions of at least one exemplary embodiments of the invention will be provided below so as to help understand basic principles of the invention. The sections below should not be understood as including all the possible exemplary embodiments of the invention and as identifying a key element among all the elements of the invention and covering the scopes of all the exemplary embodiments of the invention. The unique object of the descriptions below should be understood as being an introduction to a detailed description of the invention so as to provide the basic concept of at least one simplified exemplary embodiment.

Exemplary embodiments of the invention provide a method and apparatus capable of verifying a service user's actual visit to a service-providing place and provide various benefits to the service user accordingly.

Exemplary embodiments of the invention also provide a method and apparatus capable of rewarding a service user not only for his or her accumulated number of visits to each service-providing place, but also for his or her accumulated number of visits to each individual service provider, and allowing the service user to evaluate each individual service provider. Exemplary embodiments of the invention also provide a method and apparatus capable of ensuring that an evaluation of a service can be done only by a service user who has actually received the service.

Exemplary embodiments of the invention also provide a method and apparatus capable of verifying a service user's receipt of a service from a particular service provider.

Exemplary embodiments of the invention also provide a method and apparatus capable of offering new experience for both a service user and a service provider to collect and award rewards points or stamps via a new interface.

### Technical Solutions

According to an aspect of the invention, there is provided a system for recording visit data of a wireless communication device. The system includes: an electronic device, which has one or more sensors capable of sensing position and motion; an electronic device, which has one or more sensors capable of sensing position and motion; and a server, which transmits visit data validating the wireless communication device's visit to a place where the electronic device is installed to the wireless communication device if the presence of the wireless communication device within a predetermined distance from the electronic device is verified by the sensors included in the electronic device and the sensors included in the wireless communication device and a predetermined motion condition is met.

According to another aspect of the invention, there is provided a method of recording visit data of a wireless communication device. The method includes: transmitting data indicating that a predetermined place has been visited by a wireless communication device from an electronic device to a server; transmitting data indicating that the predetermined place has been visited by the wireless communication device from the wireless communication device to the server; and transmitting visit data validating the wireless communication device's visit to the predetermined place from the wireless communication device.

The method may also include displaying the visit data on the wireless communication device in a predetermined form.

According to another aspect of the invention, there is provided a data transmission device, which is connected to a server and transmits visit data to a wireless communication device. The data transmission device includes: a handle unit, which is formed of a conductive material; a button unit, which is connected to the handle unit and transmits data indicating that visit data is to be transmitted to the wireless communication device to the server in response to a button thereof being pressed; and a touch screen touch unit which is connected to the button unit and allows an electric signal to be input to a touch screen of the wireless communication device, wherein the visit data is transmitted to the wireless communication device if the button is pressed and an electric signal is input to the touch screen.

The visit data may be transmitted to the wireless communication device only if the button is pressed within a predetermined period of time after the time when an electric signal is input to the touch screen of the wireless communication device.

The handle unit may be formed of a conductive material for transmitting a current for inputting an electric signal to the touch screen.

The data transmission device may also include a computer connection unit which connects the data transmission device to a computer.

The touch screen touch unit may receive an electric signal from the computer or the data transmission device to input an electric signal to the touch screen.

According to another aspect of the invention, there is provided a data transmission device, which is connected to a server and transmits visit data to a wireless communication device. The data transmission device includes: a sensor unit which includes a motion sensor; and a touch screen touch unit which is connected to the sensor unit and is for touching a touch screen of the wireless communication device, wherein the visit data is transmitted to the wireless communication device if the presence of the wireless communication device at a place where the data transmission device is located is verified by a position sensor of the wireless communication device and the movement of the data transmission device upon the touch screen touch unit touching a touch screen of the wireless communication device is sensed by the sensor unit.

According to another aspect of the invention, there is provided a data transmission device, which is connected to a server and transmits visit data to a wireless communication device. The data transmission device includes: a button unit which transmits data indicating that the visit data is to be transmitted to the wireless communication device to the server in response to a button thereof being pressed; and a touch screen touch unit which is connected to the button unit and allows an electric signal to be input to a touch screen of the wireless communication device, wherein the visit data is transmitted to the wireless communication device if the presence of the wireless communication device at a place where the data transmission device is located is verified by a position sensor of the wireless communication device, the button is pressed and the movement of the data transmission device upon the touch screen touch unit touching a touch screen of the wireless communication device is sensed by a sensor unit of the wireless communication device.

### Advantageous Effects

According to the aspects of the invention, it is possible to verify a service user's actual visit to a service-providing place and provide various benefits to the service user accordingly.

In addition, it is possible to prevent a service user from having his or her visit falsely validated and evaluating a service.

Moreover, it is possible to reward a service user not only for his or her accumulated number of visits to each service-providing place, but also for his or her accumulated number of visits to each individual service provider, and allow the service user to evaluate each individual service provider.

Furthermore, it is possible to offer new experience for both a service user and a service provider to collect and award rewards points or stamps via a new interface.

In order to achieve the above described objects and related other objects, at least one embodiment will be described below along with the features recited in claims. Exemplary aspects of the invention may be well be understood along with the descriptions and drawings below. It should be understood that such aspects are provided for only illustrations, and it is obvious that those skilled in the art may pursue a variety of modifications. The disclosed embodiments should be interpreted as including the above embodiments and all the equivalents of such embodiments.

### BRIEF DESCRIPTION OF DRAWINGS

Some features may not necessarily be illustrated based on their actual size. The dimensions of such features, therefore, may be randomly enlarged and contracted for simplicity. It should be noted that part of the drawings may be simplified for simplicity. The drawings below may not necessarily illustrate all the components of the apparatus (or device) or the method as disclosed herein. Similar or like reference numbers may be used to represent similar or features throughout the specification and the drawings.

FIG. 1 is a block diagram of a system for recording visit data according to an exemplary embodiment of the invention.

FIG. 2 is a schematic diagram illustrating the recording of visit data according to an exemplary embodiment of the invention.

FIG. 3 is a schematic diagram illustrating the recording of visit data according to another exemplary embodiment of the invention.

FIG. 4 is a schematic diagram illustrating a data transmission device according to an exemplary embodiment of the invention.

FIG. 5 is a schematic diagram illustrating a method of recording visit data using the data transmission device of FIG. 4.

FIG. 6 is a flowchart illustrating a method of recording visit data according to an exemplary embodiment of the invention.

FIG. 7 is a schematic diagram illustrating the displaying of visit data transmitted to an electronic device of a service user on the screen of the electronic device in a predetermined form according to an exemplary embodiment of the invention.

### BEST MODES FOR CARRYING OUT THE INVENTION

Various exemplary embodiments of the invention will hereinafter be described with reference to the accompanying drawings. Similar or like reference numbers represent similar or like elements throughout the drawings. Various descriptions are presented herein for a better understanding of the invention. It is obvious that exemplary embodiments of the invention can be implemented without any specific descriptions. For ease of description, well-known structures and apparatuses are explained herein using block diagrams.

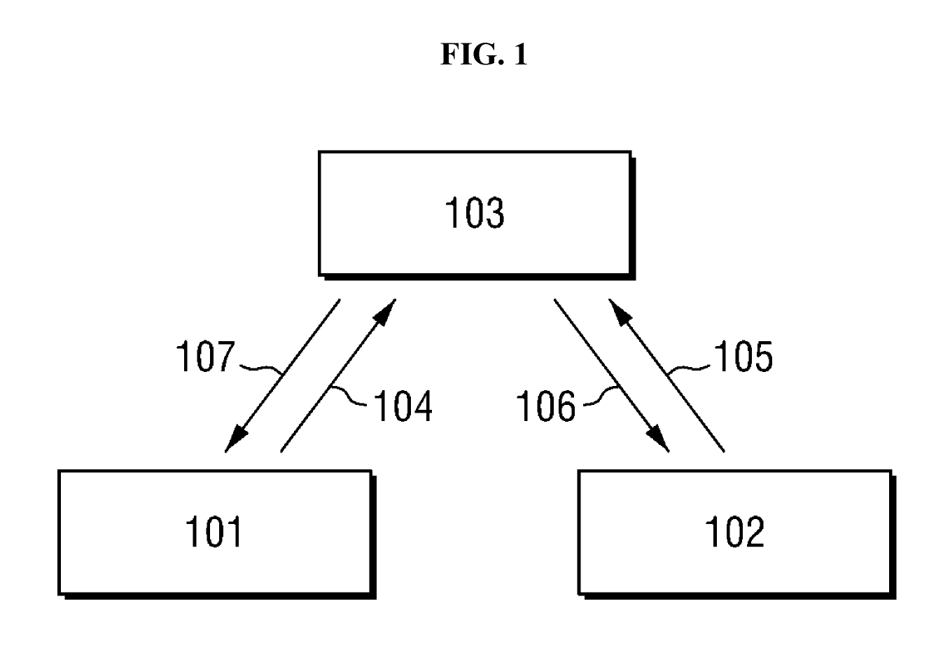

FIG. 1 is a block diagram of a system for recording visit data according to an exemplary embodiment of the invention.

Referring to FIG. 1, an electronic device 101 of a service provider, an electronic device 102 of a service user and a server 103 are disclosed.

The electronic device 101 and 102 may refer to, but is not limited to, a Point-of-Sale (POS) terminal, a smartphone, a smart pad, and a computer with a Global Positioning System (GPS) sensor, a gyro sensor, an acceleration sensor, or a motion sensor capable of sensing position, acceleration or motion.

The service user's electronic device 102 may be a wireless communication device such as a smartphone or a smart pad.

Nearly all types of computer programs that can be connected to the server 103 may be installed in the electronic devices 101 and 102. In response to the electronic devices 101 and 102 being smartphones or smart pads, applications may be installed in the electronic devices 101 and 102.

In the server 103, a service provider account and a service user account may be created.

The service provider account may be created for each service providing place or for each service provider.

The service provider's electronic device 101 may be located at a predetermined place (such as, for example, a place where services are to be provided). For example, the service provider's electronic device 101 may be a POS terminal or computer provided in a coffee shop or a hair salon. In response to the service provider's electronic device 101 being a wireless communication device such as a smartphone or a smart pad, visit data may be configured to be transmitted to the service user's electronic device 102 only if the presence of the service provider's electronic device 101 in a predetermined place is verified by a position sensor (for example, a GPS sensor) included in the service provider's electronic device 101.

If a predetermined place where the service provider's electronic device 101 is located has been visited by the service user's electronic device 102, the service provider's electronic device 101 may provide data indicating that the predetermined place has been visited by the service user's electronic device 102 to the server 103 (104), and the service user's electronic device 102 may provide data indicating that the predetermined place has been visited by the service user's electronic device 102 to the server 103 (105).

If the data provided by the service provider's electronic device 101 and the data provided by the service user's electronic device 102 match, the server 103 may transmit visit data to the service user's electronic device 102 (106). Also, the server 103 may store visit data of the service user's electronic device 102.

The visit data transmitted to the service user's electronic device 102 may be displayed in a predetermined form.

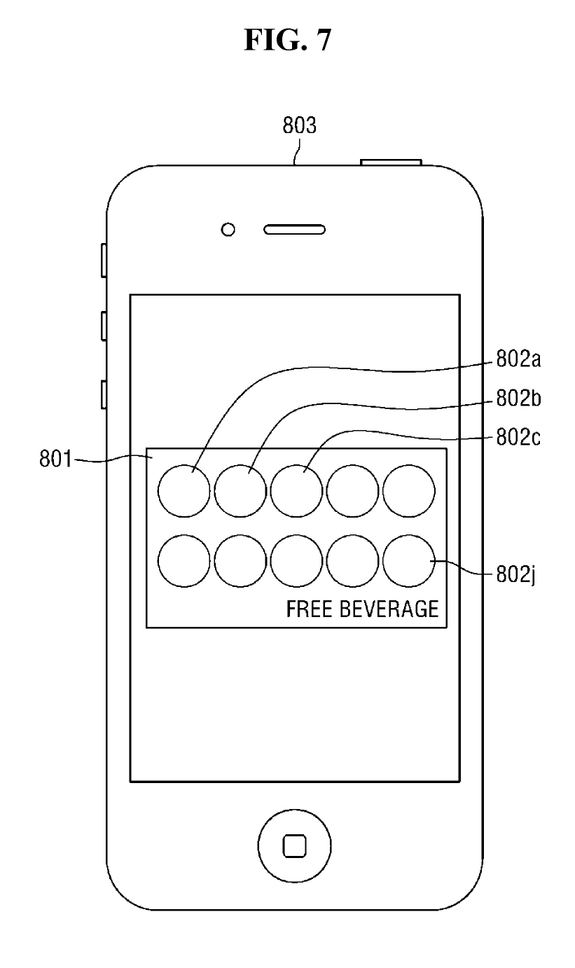

FIG. 7 illustrates an example of displaying visit data transmitted to an electronic device 803 of a service user on the screen of the electronic device 803 in a predetermined form.

Referring to FIG. 7, the service user's electronic device 803 may be a smartphone or a smart pad, and a rewards card such as a typical paper stamp card may be displayed on the screen of the service user's electronic device 803. The stamp card has slots 802a, 802b, 802c, . . . 802j, and visit data may be displayed in each of the slots 802a, 802b, 802c, . . . 802j in a predetermined pattern according to the service user's number of visits.

Referring back to FIG. 1, the service user's electronic device 102 may transmit data regarding the use of accumulated rewards points to the server 103 (105), and the server 103 may transmit data regarding the use of accumulated rewards points to the service provider's electronic device 101 (107).

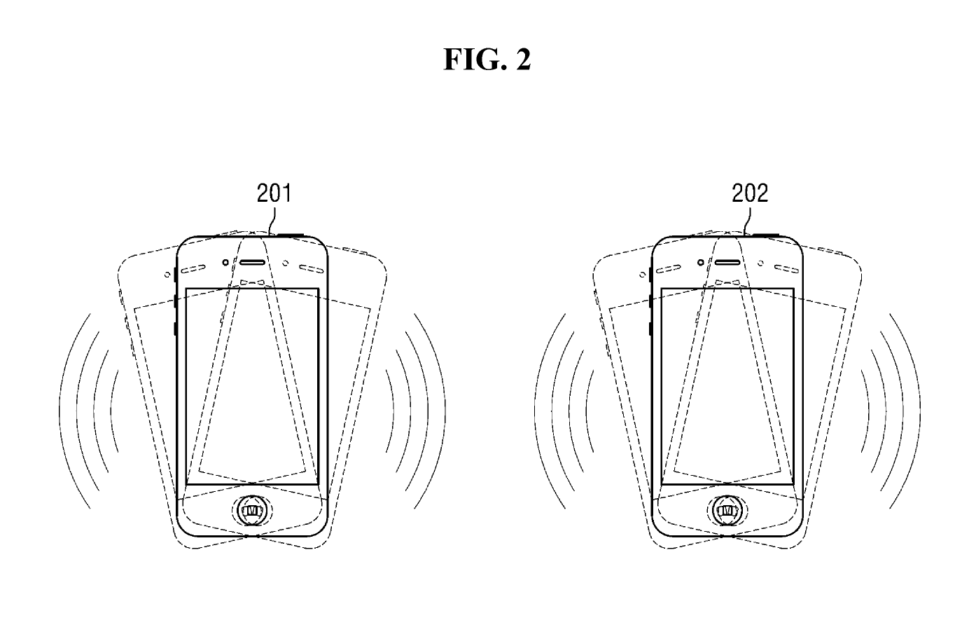

FIG. 2 is a schematic diagram illustrating the recording of visit data according to an exemplary embodiment of the invention.

Referring to FIG. 2, an electronic device according to an exemplary embodiment of the invention may include a gyro sensor or an acceleration sensor capable of sensing motion of the electronic device.

For example, U.S. Patent Application No. 2011/0191823, filed on Aug. 4, 2011 by Bump Technologies, Inc., discloses a data transmission method referred to as a “bump”.

In this data transmission method, when two smartphones indicate their intention to establish a connection for transferring information by causing a particular motion at the same place at the same time with the use of their location and motion sensors, information may be transferred from one of the two smartphones to a server, and may then be transferred from the server to the other smartphone.

Analogously to this data transmission method, a server may be configured to transmit visit data to an electronic device 202 of a service user, indicating that the service user's electronic device 202 is being present at a predetermined place where an electronic device 201 of a service provider is located, if the presence of the service user's electronic device 202 at the predetermined place is sensed by a position sensor (for example, if the distance between the location of the service provider's electronic device 201 and the location of the service user's electronic device 202, as sensed by the position sensor, is within a predetermined range), a predetermined motion condition is met (for example, if a swing from the left to the right is sensed from both the service provider's electronic device 201 and the service user's electronic device 202), and a predetermined time condition is met (for example, if the interval between the swing of the service provider's electronic device 201 and the swing of the service user's electronic device 202 is 0.5 seconds or less).

The service provider's electronic device 201 is illustrated in FIG. 2 as being a smartphone or a smart pad, but the invention is not limited thereto. That is, examples of the service provider's electronic device 201 may include arbitrary electronic devices having a position sensor, an acceleration sensor, a gyro sensor, etc.

The server may also be configured to transmit the service user's electronic device 202 if the service provider's electronic device 201 and the service user's electronic device 202 are determined to be at the same place by a position sensor and an input of a predetermined key is received from both the service provider's electronic device 201 and the service user's electronic device 202.

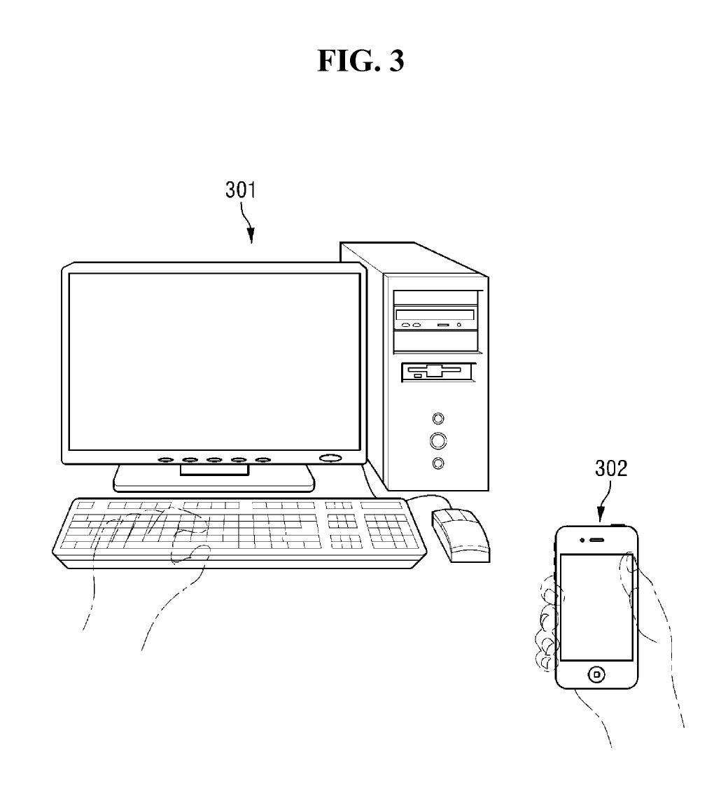

FIG. 3 is a schematic diagram illustrating the recording of visit data according to another exemplary embodiment of the invention.

Referring to FIG. 3, an electronic device 301 of a service provider may be a POS terminal or a computer.

If a predetermined key (for example, a spacebar) of the service provider's electronic device 301 is pressed, the presence of an electronic device 302 of a service user at a predetermined place where the service provider's electronic device 301 is located is sensed and a predetermined motion (for example, a swing from the left to the right) is sensed from the service provider's electronic device 301 within a predetermined time period (for example, within 0.5 seconds or less after the pressing of the predetermined key of the service user's electronic device 302), a server may receive a signal indicating that the predetermined key of the service provider's electronic device 301 has been pressed from the service provider's electronic device 301, receive a signal indicating that the predetermined motion has been sensed from the service user's electronic device 302 at the predetermined place from the service user's electronic device 302, transmit visit data to the service user's electronic device 302, and store visit data therein.

The visit data transmitted to the service user's electronic device 302 may be displayed on the screen of the service user's electronic device 302 in the form of, for example, a stamp card, as illustrated in FIG. 7.

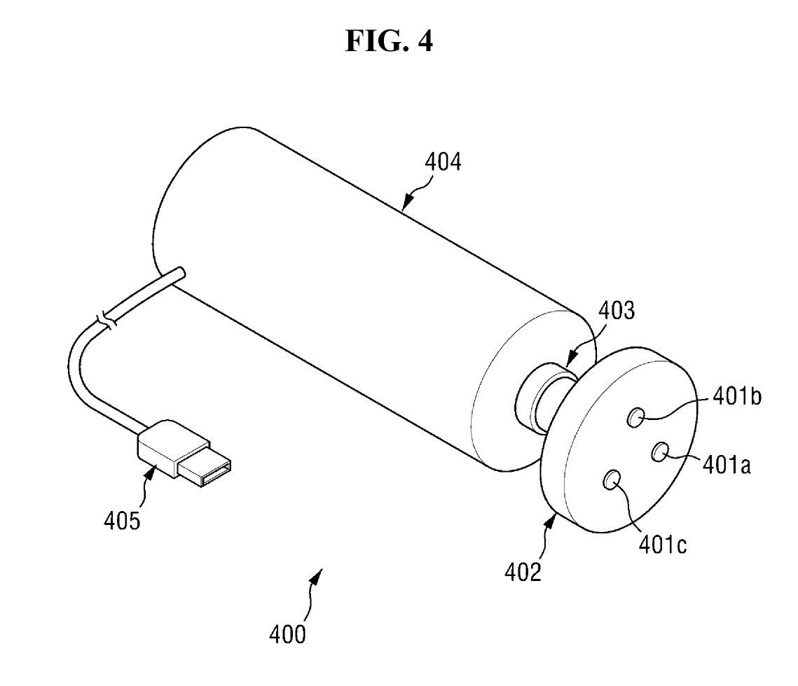

FIG. 4 is a schematic diagram illustrating a data transmission device according to an exemplary embodiment of the invention.

Referring to FIG. 4, a data transmission device 400, which is connected to a server and transmits visit data to an electronic device of a service user, is disclosed. The data transmission device 400 may include: a handle unit 404; a button unit 403, which is connected to the handle unit 404 and transmits data indicating that visit data is to be transmitted to the service user's electronic device to the server in response to a button thereof being pressed; and touch screen touch units 401a, 401b and 401c, which are connected to the button unit 403 and allow an electric signal to be input to the touch screen of the service user's electronic device. In response to the button being pressed and an electric signal being input to the touch screen of the service user's electronic device accordingly, the visit data may be transmitted to the service user's electronic device. The data transmission device 400 may include a computer connection unit 405, which connects the data transmission device 400 to various computers where computer programs for transmitting the visit data are installed.

The handle unit 404 may be formed of, for example, a conductive material. Accordingly, in response to the handle unit 404 being gripped with a hand, an electric signal from the hand may be input to the touch screen of the service user's electronic device through the button unit 403 and the touch screen touch units 401a, 401b and 401c.

Alternatively, in response to the handle unit 404 not being formed of a conductive material, the touch screen touch units 401a, 401b and 401c may receive an electric signal from a computer to which the data transmission device 400 is connected or from the data transmission device 400, and may input the electric signal to the touch screen of the service user's electronic device.

For example, the touch screen touch units 401a, 401b and 401c may be implemented as buttons. Accordingly, in response to the touch screen touch units 401a, 401b and 401c being in touch with the touch screen of the service user's electronic device, an electric signal indicating that the buttons of the touch screen touch units 401a, 401b and 401c have been pressed may be input to the data transmission device 400 or the computer to which the data transmission device 400 is connected, and as a result, an electric signal from the computer or an electric signal from the data transmission device 400 may be input to the touch screen of the service user's electronic device. Therefore, even if the handle unit 404 is not formed of a conductive material, an electric signal can be transmitted to the touch screen of the service user's electronic device, via a current flowing in the data transmission device 400 or the computer to which the data transmission device 400 is connected, by touching the touch screen touch units 401a, 401b and 401c. Thus, a user of the data transmission device 400 can use the data transmission device 400 with gloves on.

The term “button”, as used herein, may refer to not only a physical button, but also an electric button, and may mean that the touch screen touch units 401a, 401b and 401c include nearly all means available for physically or electrically sensing an object in touch with the touch screen of the service user's electronic device.

The button unit 403 may be configured to have a button pressed in response to the handle unit 404 being gripped with a hand and the touch screen touch units 401a, 401b and 401c being pressed against the touch screen of the service user's electronic device. In response to the button of the button unit 403 being pressed, the server may determine that the service user's electronic device and the touch screen touch units 401a, 401b and 401c are in contact with each other. That is, the button of the button unit 403 being pressed may mean that the service user has come to the place where the data transmission device 400 is installed with his or her electronic device and has made the service user's electronic device contact the data transmission device 400. When the button of the button unit 403 is pressed, which means that the service user's electronic device is being present at the place where the data transmission device 400 is installed, the server may receive data indicating that visit data is to be transmitted to the service user's electronic device.

For example, the touch screen touch units 401a, 401b and 401b may be formed of a conductive material. In the current exemplary embodiment, three touch screen touch units 401a, 401b and 401c are provided, but the invention is not limited thereto. That is, alternatively, only one touch screen touch unit or more than three touch screen touch units may be provided.

The touch screen touch units 401a, 401b and 401c may be surrounded by a protective unit 402, which is formed of a nonconductive material that does not cause damage to a touch screen.

By placing the touch screen of the service user's electronic device in touch with the touch screen touch units 401a, 401b and 401c, data indicating that the place where the data transmission device 400 is located has been visited by the service user's electronic device may be transmitted to the server, and in response to the button of the button unit 403 being pressed to input an electric signal to the touch screen of the service user's electronic device, visit data may be transmitted from the server to the service user's electronic device.

For example, the visit data may be transmitted to the touch screen of a wireless communication device (the service user's electronic device) only if the button of the button unit 403 is pressed within a predetermined period of time after the input of the electric signal to the touch screen of the wireless communication device (the service user's electronic device).

The visit data transmitted to the service user's electronic device may be displayed on the screen of the service user's electronic device in the form of, for example, a stamp card as illustrated in FIG. 7.

Whether the button unit 403 of the data transmission device 400 is pressed has been described so far as a condition for transmitting visit data, but the invention is not limited thereto. That is, alternatively, the data transmission device 400 may include a motion sensor, a gyro sensor and/or an acceleration sensor, and visit data may be configured to be transmitted upon detection of the motion of the data transmission device 400 by the sensors.

Whether the touch screen of the service user's electronic device is placed in touch with the touch screen touch units 401a, 401b and 401c has been described so far as a condition for transmitting data indicating that the place where the data transmission device 400 is installed has been visited by the service user's electronic device, but the invention is not limited thereto. That is, alternatively, the touch screen touch units 401a, 401b and 401c may physically press the touch screen of the service user's electronic device to move the service user's electronic device, instead of inputting an electric signal, and in response to the movement of the service user's electronic device being detected by sensors included in the service user's electronic device, data indicating that the place where the data transmission device 400 is installed has been by the service user's electronic device may be transmitted to the server.

In an exemplary embodiment, the service user's electronic device may be placed on a support formed of an elastic material. In this exemplary embodiment, in response to the service user's electronic device being pressed with the touch screen touch units 401a, 401b and 401c, the service user's electronic device may be moved due to the elasticity of the support, and the movement of the service user's electronic device may be sensed. Then, data indicating that the place where the data transmission device 400 is installed has been visited by the service user's electronic device may be transmitted to the server.

The presence of the data transmission device 400 and the service user's electronic device at the same place may be determined based on the location of a POS terminal or a main computer to which the data transmission device 400 is connected and the location sensed by the position sensor (for example, a GPS sensor) of the service user's electronic device, or may be determined based on the location sensed by a position sensor, if any, of the data transmission device 400 and the location sensed by the position sensor of the service user's electronic device.

In another exemplary embodiment, the data transmission device 400 may include a button unit, which transmits data indicating that visit data is to be transmitted to a wireless communication device (the service user's electronic device) to the server; and at least one touch screen touch unit, which is connected to the button unit and is for touching the touch screen of the wireless communication device, and the wireless communication device may transmit data indicating that the wireless communication device is being present at the place where the data transmission device 400 is located to the server with the use of a location sensor and a motion sensor thereof. For example, the wireless communication device may be placed on a support with elasticity. In response to the touch screen touch unit of the data transmission device 400 touching the touch screen of the wireless communication device, the button unit of the data transmission device 400 may be pressed, and the movement of the wireless communication device upon the wireless communication device and the support being pressed by the touch screen touch unit of the data transmission device 400 may be sensed. Then, the wireless communication device may transmit data indicating that the touch screen of the wireless communication device is being touched by the touch screen touch unit of the data transmission device 400 to the server, and the server may transmit visit data to the wireless communication device.

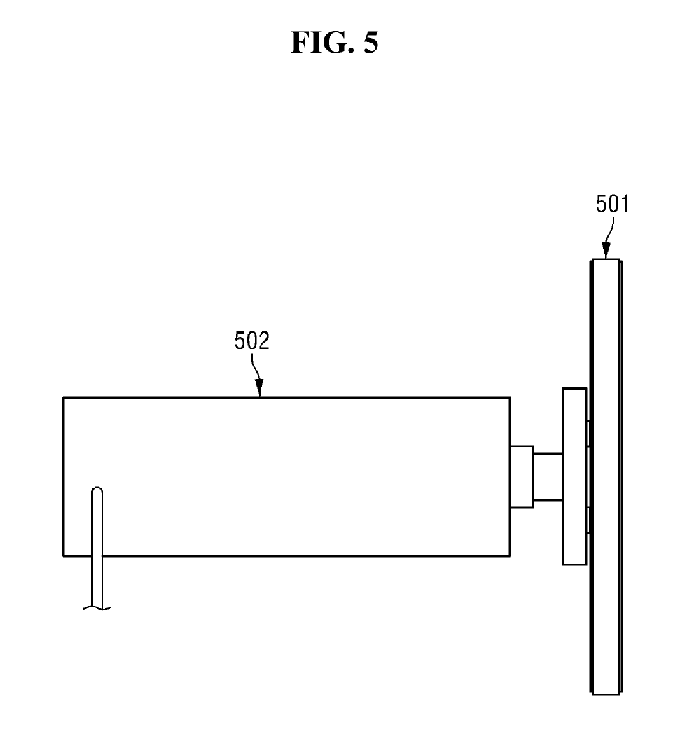

FIG. 5 is a schematic diagram illustrating a method of recording visit data using the data transmission device of FIG. 4.

Referring to FIG. 5, by placing a touch screen touch unit of a data transmission device 502 in touch with an electronic device 501 of a service user, visit data may be input to the service user's electronic device 501 in the form of a stamp card as illustrated in FIG. 7.

Accordingly, rewards points or stamps may be collected via an interface that can allow the service user to feel as if he or she is having the stamp card displayed on the touch screen of the service user's electronic device 501 stamped with the data transmission device 502, which is formed in the shape of a seal. Thus, new user experience can be offered to both the service user and a service provider, intriguing them into collecting or awarding rewards points or stamps.

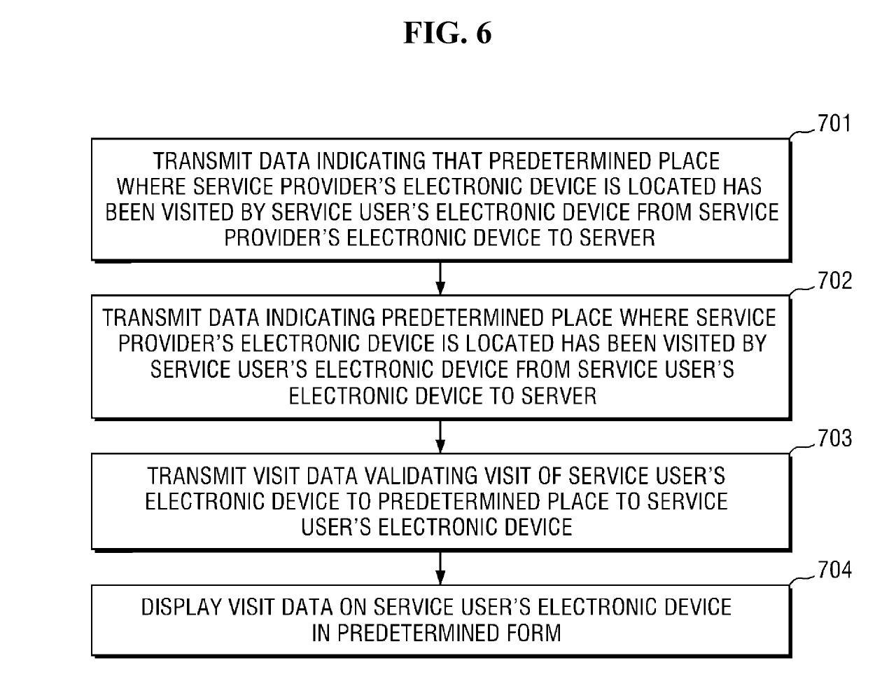

FIG. 6 is a flowchart illustrating a method of recording visit data according to an exemplary embodiment of the invention.

Referring to FIG. 6, data indicating that a predetermined place where an electronic device of a service provider is located has been visited by an electronic device of a service user may be transmitted from the service provider's electronic device to a server (701). Thereafter, data indicating that the predetermined place has been visited by the service user's electronic device may be transmitted from the service user's electronic device to the server (702). Thereafter, visit data validating the visit of the service user's electronic device to the predetermined place may be transmitted to the service user's electronic device (703). Thereafter, the visit data may be displayed on the service user's electronic device in a predetermined form (704).

For example, a service provider account and a service user account may be created on an application. For example, the term “service provider”, as used herein, encompasses a service-providing place, and the name of the service-providing place, the type and classification of service provided, the location of the service-providing place, information on the representative of the service-providing place, and information on each individual service provider at the service-providing place may be input to create the service provider account. For example, the service provider account may be created for each place such as a restaurant, a coffee shop, a hair salon, a nail salon, etc., or for each individual service provider such as a waiter/waitress, a barista, a hair designer, a nail technician, etc.

The service user account may be created in various manners. The service user may create an account on an application on the web or a smartphone (including a tablet personal computer (PC)) by inputting his or her personal information, for example, the name, the social security number, an email address, etc. Alternatively, the service user may create an account, without the need to input his or her personal information, by install an application on his or her smartphone or paying a visit to the service-providing place and using the unique serial number or identifier (ID) (such as an iPhone's Unique Identifier (UDID)) of his or her smartphone. For example, the service user account created in the aforementioned manner may be stored in a smartphone and may thus be verified by the service-providing place.

The visit data, which validates the service user's visit, may be accumulated for each service-providing place or for each individual service provider. That is, the valid data may be accumulated for each visit to the service-providing place, for example, a café, or each visit to a service provider at the service-providing place, for example, a particular barista. To accumulate the visit data for each visit to the particular barista, the visit data may be transmitted to the service user's electronic device from a smartphone logged on with the particular barista's account, or from a data transmission device allocated to the particular barista's account.

The visit may be stored and accumulated in a server. The visit data may be displayed on the service user's electronic device in the form of a stamp card, and may be stored and accumulated in the server as, for example, the service user's number of visits to the service-providing place, the location of the service-providing place, a list of orders made by the service user, and the amount of the orders. The visit data may be data regarding the use of services provided by the service-providing place or each service provider at the service-providing place. For example, in a case when the service user receives a “haircut” service from service provider A and a “hair perm” service from service provider B at the same hair salon, the visit data may be stored for the hair salon to indicate the receipt of the “haircut” service and the “hair perm” service from the hair salon or to indicate the receipt of the “haircut” service and the “hair perm” service from service provider A and service provider B, respectively. The visit data may be fetched from the server and checked any time by both a service provider and the service user.

Thereafter, the service user may be rewarded according to the accumulated visit data.

For example, if the accumulated visit data indicates that the service user's total number of visits to the service-providing place has reached 10, a free-of-charge service coupon may be issued to the service user. For example, the service user may become eligible for rewards points, the redemption of rewards points, or gifts, but the invention is not limited thereto. Such rewards information may be fetched from the server and checked any time by both a service provider and the service user.

The service user may be rewarded by the service-providing place or each individual service provider at the service-providing place. That is, the service-providing place, for example, a hair salon, or an individual service provider at the service-providing place, for example, a hair designer at the hair salon, may give a free haircut for every tenth visit to the service user. Since the service user can be rewarded not only by the service-providing place, but also by each individual service provider at the service-providing place, the service user can continue to earn rewards points from, and benefit from, the same service provider even if the service provider transfers from one service-providing place to another service-providing place.

Thereafter, the service user may input a service-providing place evaluation or an individual service provider evaluation to the server.

The content of the service-providing place evaluation or the individual service provider evaluation may be shared with other service users through a Social Network Service (SNS) such as Facebook or through another application. The individual service provider evaluation may be configured to be reviewed only by the representative of the service-providing place. The representative of the service-providing place may reward or penalize each individual service provider at the service-providing place based on the individual service provider evaluation.

Alternatively, a survey may be conducted, for example, among the participants of an offline gathering, by allowing only those with electronic devices that have ever received the visit data to answer the questionnaire or to vote.

According to an exemplary embodiment of the invention, there is provided a system for recording visit data of a wireless communication device. The system includes: a wireless communication device, which has one or more sensors capable of sensing position and motion; an electronic device, which has one or more keys for transmitting data to a server; and the server, which transmits visit data validating the wireless communication device's visit to a place where the electronic device is installed to the wireless communication device, wherein the server transmits the visit data validating the wireless communication device's visit to the place where the electronic device is installed to the wireless communication device if the presence of the wireless communication device at the place where the electronic device is installed is verified by the sensors, a predetermined key, among the keys of the electronic device, is pressed, and a predetermined motion is sensed from the wireless communication device by the sensors.

For example, the predetermined key may be a spacebar, and the predetermined motion may be a swing of the wireless communication device from the left to the right.

For example, the visit data may be configured to be transmitted only if the interval between the time when the predetermined key is pressed and the time when the predetermined motion is sensed from the wireless communication device meets a predetermined condition.

For example, the visit data may be configured to be transmitted if the interval between the time when the predetermined key is pressed and the time when the predetermined motion is sensed from the wireless communication device is 5 seconds or less.

For example, the visit data may be configured to be transmitted only if the presence of the wireless communication device at the place where the electronic device is installed, as sensed by the sensors, meets a predetermined condition.

For example, the visit data may be configured to be transmitted only if the location sensed by the position sensor of the wireless communication device is within 5 km of a location known to be the place where the electronic device is installed.

The location known to be the place where the electronic device is installed may be sensed by a position sensor included in the electronic device or may be identified from the location of a shop or store registered as having the electronic device installed therein or the location of a service provider at the shop or store.

According to another exemplary embodiment of the invention, there is provided a system for recording visit data of a wireless communication device. The system includes: a wireless communication device, which has one or more keys for transmitting data to a server; an electronic device, which has one or more keys for transmitting data to the server; and the server, which transmits visit data validating the wireless communication device's visit to a place where the electronic device is installed to the wireless communication device, wherein the server transmits the visit data validating the wireless communication device's visit to the place where the electronic device is installed to the wireless communication device if the presence of the wireless communication device at the place where the electronic device is installed is verified by the sensors, a predetermined key, among the keys of the electronic device, is pressed, and a predetermined key, among the keys of the wireless communication device, is pressed.

For example, the predetermined key of the wireless communication device may be a button displayed on the display (for example, a touch screen) of the wireless communication device when an application installed in the wireless communication device is being run, and the predetermined key of the electronic device may be a spacebar.

For example, the visit data may be configured to be transmitted only if the interval between the time when the predetermined key of the electronic device is pressed and the time when the predetermined key of the wireless communication device is pressed meets a predetermined condition.

For example, the visit data may be configured to be transmitted if the interval between the time when the predetermined key is pressed and the time when the predetermined key of the wireless communication device is pressed is 5 seconds or less.

For example, the visit data may be configured to be transmitted only if the presence of the wireless communication device at the place where the electronic device is installed, as sensed by the sensors, meets a predetermined condition.

For example, the visit data may be configured to be transmitted only if the location sensed by the position sensor of the wireless communication device is within 5 km of a location known to be the place where the electronic device is installed.

The location known to be the place where the electronic device is installed may be sensed by a position sensor included in the electronic device or may be identified from the location of a shop or store registered as having the electronic device installed therein or the location of a service provider at the shop or store.

According to at least one exemplary embodiment of the invention, the aforementioned functions may be implemented by means of hardware, software, firmware or a combination thereof. In a case when the aforementioned functions are implemented as software, they may be stored on, or transmitted via, a computer-readable medium as one or more commands or codes. Examples of the computer readable medium include a computer storage medium, and a communication medium including an arbitrary medium facilitating the transfer of computer programs from one place to another place. The storage medium may be an arbitrary medium available, which is accessible by a universal type computer or a specially designed computer. For example, the computer-readable medium may be, but is not limited to, a random access memory (RAM), a read-only memory (ROM), an electrically erasable programmable read-only memory (EEPROM), a compact disc (CD)-ROM or another optical disk storage medium, a magnetic storage medium or another magnetic storage device or another arbitrary medium which can be used to store program code means in the form of commands or data structures and is assessable by a universal computer, a specially designed computer, a universal processor or a specially designed processor. In addition, arbitrary connection means may be identified as the computer-readable medium. For example, in a case when software is transferred from a website, a server or another remote source through wireless communication technology, for example, by means of a coaxial cable, an optical fiber cable, a stranded cable, a digital subscriber line (DSL) or an infrared ray radio and a microwave, such wireless communication technology may fall within the scope of the computer-readable medium. The term “disk” or “disc”, as used herein, encompasses a compact disc, a laser disc, an optical disc, a digital versatile disc (DVD), a floppy disk, and a blue-ray disc. More specifically, a “disk” is configured to magnetically reproduce data, whereas a “disc” is configured to optically reproduce data by means of laser. A combination of a “disk” and a “disc” may also fall within the range of the computer-readable medium.

Data communication between a server and a terminal may be conducted via nearly all means available for short- and long-range communication.

While the invention has been particularly shown and described with reference to exemplary embodiments thereof, it will be understood by those of ordinary skill in the art that various changes may be made therein without departing from the spirit and scope of the invention as defined by the following claims. The exemplary embodiments should be considered in a descriptive sense only and not for purposes of limitation.

What is claimed is:

1. A data transmission device, which is connected to a server and transmits visit data to a wireless communication device, comprising:
a button unit which transmits data indicating that the visit data is to be transmitted to the wireless communication device to the server in response to a button thereof being pressed; and
a touch screen touch unit which is connected to the button unit and allows an electric signal to be input to a touch screen of the wireless communication device,
wherein the visit data is transmitted to the wireless communication device if the button is pressed and an electric signal is input to the touch screen.

2. The data transmission device of claim 1, further comprising:
a handle unit,
wherein the handle unit is formed of a conductive material for transmitting a current for inputting an electric signal to the touch screen.

3. The data transmission device of claim 1, further comprising:
a computer connection unit which connects the data transmission device to a computer,
wherein the touch screen touch unit receives an electric signal from the computer or the data transmission device to input an electric signal to the touch screen.

4. A data transmission device, which is connected to a server and transmits visit data to a wireless communication device, comprising:
a sensor unit which includes a motion sensor; and
a touch screen touch unit which is connected to the sensor unit and is for touching a touch screen of the wireless communication device,
wherein the visit data is transmitted to the wireless communication device if the presence of the wireless communication device at a place where the data transmission device is located is verified by a position sensor of the wireless communication device and the movement of the data transmission device upon the touch screen touch unit touching a touch screen of the wireless communication device is sensed by the sensor unit.

5. A data transmission device, which is connected to a server and transmits visit data to a wireless communication device, comprising:
a button unit which transmits data indicating that the visit data is to be transmitted to the wireless communication device to the server in response to a button thereof being pressed; and
a touch screen touch unit which is connected to the button unit and allows an electric signal to be input to a touch screen of the wireless communication device,
wherein the visit data is transmitted to the wireless communication device if the presence of the wireless communication device at a place where the data transmission device is located is verified by a position sensor of the wireless communication device, the button is pressed and the movement of the data transmission device upon the touch screen touch unit touching a touch screen of the wireless communication device is sensed by a sensor unit of the wireless communication device.
